(19) United States
(12) Patent Application Publication
(10) Pub. No.: US 2026/0018899 A1
(43) Pub. Date: Jan. 15, 2026

(54) IMPEDANCE SOURCES (Z SOURCES) WITH INHERENT FAULT PROTECTION FOR RESILIENT AND FIRE-FREE ELECTRICITY GRIDS

(71) Applicant: Florida State University Research Foundation, Inc., Tallahassee, FL (US)

(72) Inventors: Fang Zheng Peng, Tallahassee, FL (US); Yuan Li, Tallahassee, FL (US)

(21) Appl. No.: 19/265,732

(22) Filed: Jul. 10, 2025

Related U.S. Application Data
(60) Provisional application No. 63/669,775, filed on Jul. 11, 2024.

(51) Int. Cl. H02J 3/38; H02J 3/00

(52) U.S. Cl. CPC H02J 3/38; H02J 3/001

(57) ABSTRACT

Systems and methods are provided for re-making/re-engineering electricity power grids to be self-protected, fault-current and/or fault-voltage limited, fast recoverable, and therefore resilient to natural and human-made disasters. Impedance source concepts and models can provide methodological approaches to re-make/re-engineer the electricity power grid(s). All sources can be fault-protected active impedance (Z) sources, and/or all grid circuits can be made resistive or resistance-dominant by using power converters/inverters as virtual/active resistors to transform grids to dominantly resistive systems.

### CROSS-REFERENCE TO RELATED APPLICATION

This application claims the benefit of U.S. Provisional Application Ser. No. 63/669,775, filed Jul. 11, 2024, the disclosure of which is hereby incorporated by reference in its entirety, including all figures, tables, and drawings.

### GOVERNMENT SUPPORT

This invention was made with government support under DE-EE0009340 awarded by the Department of Energy. The government has certain rights in the invention.

### BACKGROUND

Modern societies would not survive without electricity and at the same time electrical faults could cause and have caused many catastrophes (e.g., deadly fires). There are two types of electricity sources: voltage sources such as generators, charged batteries, and capacitors; and current sources such as charged inductors, current-regulated rectifiers, and superconducting magnetic energy storage. An “ideal” voltage source, which is often sought or intentionally engineered, generates a constant voltage irrespective of its load current, and an “ideal” current source injects a constant current irrespective of its load voltage. However, two problems exist. First, voltage or current sources do not represent many emerging natural/renewable energy sources such as wind turbine generators, photovoltaic cells, and fuel cells, whose output voltage and current are strongly dependent on each other. Second, a short-circuit fault to an artificially-made and controlled “ideal” voltage source or an open-circuit fault to an “ideal” current source can cause catastrophic failures of the source itself and its surrounding circuits due to large (theoretically infinite) short-circuit current or open-circuit voltage.

### BRIEF SUMMARY

Embodiments of the subject invention provide novel and advantageous systems and methods for re-making/re-engineering electricity power grids to be self-protected, fault-current and/or fault-voltage limited, fast recoverable, and therefore resilient to natural and human-made disasters. Impedance source concepts and models can provide methodological approaches to re-make/re-engineer the electricity power grid(s). All sources can be fault-protected active impedance (Z) sources, and/or all grid circuits can be made resistive or resistance-dominant by using power converters/inverters as virtual/active resistors to transform grids to dominantly resistive systems.

In an embodiment, a system for a resilient power grid can comprise: at least one power source, wherein each power source of the at least one power source is a fault-protected active impedance source; and at least one grid circuit in operable communication with the at least one power source, wherein each grid circuit of the at least one grid circuit is a resistance-dominant grid circuit. Each grid circuit of the at least one grid circuit can comprise: a) a power converter as a virtual resistor (e.g., a plurality of power converters as a plurality of virtual resistors, respectively); b) a power inverter as an active resistor (e.g., a plurality of power inverters as a plurality of active resistors, respectively); or c) both a) and b). The at least one power source can comprise a plurality of power sources, and/or the at least one grid circuit can comprise a plurality of grid circuits. The at least one power source can comprise at least one passive impedance source and/or at least one active impedance source. Each power source of the at least one power source can be a passive impedance source, or each power source of the at least one power source can be an active impedance source. The at least one power source can comprise any or all of a wind turbine generator, a photovoltaic cell, a fuel cell, a direct current-direct current (DC-DC) converter with output control, and an inverter-based source with output control. The system can be configured for fault current limiting within a period of time of less than 1000 microseconds (μs) (e.g., less than 500 μs, less than 400 μs, less than 300 μs, less than 200 μs, less than 100 μs, less than 50 μs, or less than 10 μs). The system can be configured for automatic recovery after a fault within a period of time of less than 1000 milliseconds (ms) (e.g., less than 500 ms, less than 400 ms, less than 300 ms, less than 200 ms, less than 100 ms, less than 50 ms, or less than 10 ms). The system can be configured for: protection and fault energy capturing; artificial coordination; and/or autonomous operation with no need for communication (e.g., no communication with a controller, user, or operator) (i.e., the system can be specifically configured to exclude any such communication).

In another embodiment, a method for re-engineering a power grid (comprising at least one power source and at least one grid circuit in operable communication with the at least one power source) to be resilient can comprise: making each power source of the at least one power source a fault-protected active impedance source (e.g., replacing each voltage source and each current source present with a fault-protected active impedance source, or initially installing a fault-protected active impedance source as each power source); and making each grid circuit of the at least one grid circuit a resistance-dominant grid circuit (e.g., replacing each grid circuit present with a resistance-dominant grid circuit or initially installing a resistance-dominant grid circuit as each grid circuit). Each grid circuit of the re-engineered resilient power grid can comprise: a) a power converter as a virtual resistor (e.g., a plurality of power converters as a plurality of virtual resistors, respectively); b) a power inverter as an active resistor (e.g., a plurality of power inverters as a plurality of active resistors, respectively); or c) both a) and b). The at least one power source can comprise a plurality of power sources, and/or the at least one grid circuit can comprise a plurality of grid circuits. The at least one power source can comprise at least one passive impedance source and/or at least one active impedance source. Each power source of the at least one power source can be a passive impedance source, or each power source of the at least one power source can be an active impedance source. The at least one power source can comprise any or all of a wind turbine generator, a photovoltaic cell, a fuel cell, a DC-DC converter with output control, and an inverter-based source with output control. The re-engineered resilient power grid can be configured for fault current limiting within a period of time of less than 1000 μs (e.g., less than 500 μs, less than 400 μs, less than 300 μs, less than 200 μs, less than 100 μs, less than 50 μs, or less than 10 μs). The re-engineered resilient power grid can be configured for automatic recovery after a fault within a period of time of less than 1000 ms (e.g., less than 500 ms, less than 400 ms, less than 300 ms, less than 200 ms, less than 100 ms, less than 50 ms, or less than 10 ms). The re-engineered resilient power grid can be configured for: protection and fault energy capturing; artificial coordination; and/or autonomous operation with no need for communication (e.g., no communication with a controller, user, or operator) (i.e., the re-engineered resilient power grid can be specifically configured to exclude any such communication).

### BRIEF DESCRIPTION OF DRAWINGS

FIG. 1 shows a plot of V-I characteristics of a voltage source.

FIG. 2 shows a plot of V-I characteristics of a current source.

FIG. 3 shows a plot of V-I characteristics of an impedance source (Z source).

FIG. 4A shows a symbol for an ideal voltage source.

FIG. 4B shows a symbol for an ideal current source.

FIG. 4C shows a symbol for an ideal impedance source.

FIG. 5 shows a schematic view of an open-loop wind turbine permanent magnet (PM) generator feeding a resistive load, R_{L}.

FIG. 6 shows a plot of voltage (Vₛ, per unit (pu)) versus current (I_{L}, pu), showing generator output voltage-current (V-I) characteristic curves.

FIG. 7A shows I-V characteristic curves of a typical photovoltaic (PV) cell.

FIG. 7B shows redrawn PV cell V-I characteristic curves from FIG. 7A.

FIG. 8 shows a specific V-I characteristic curve at 1000 Watts per square meter (W/m²) and its power-current (P-I) curve.

FIG. 9 shows a typical fuel cell polarization curve.

FIGS. 10A and 10B show a direct current (DC)-DC converter with output voltage/current (or resistance) control.

FIG. 10C shows a plot of voltage (Vₒ) versus current (Iₒ), with the DC-DC converter having output voltage/current (or resistance) control to behave like a voltage source (the horizontal line), a current source (the vertical line), and a Z source/resistive source (a diagonal line).

FIG. 11A shows a general inverter-based source that is controlled to behave like an active Z source that has four operation regions: normal operation; dynamic operation; protection; and auto-recovery operation, a so called “big nose” operation. The top portion of FIG. 11A shows a schematic, and the bottom portion of FIG. 11A shows Z source V-I curves for the general inverter-based source.

FIG. 11B shows a diagram of a PV cell farm inverter configuration and assumed fault locations. Each PV inverter includes an inverter bridge, an LC filter (inductor Lf and capacitor Cf), and output transformer to the local distribution and high voltage (HV) transmission line.

FIG. 11C shows simulation waveforms of the output voltage (vₒ, the upper waveform in FIG. 11C) and current (iₒ, the lower waveform in FIG. 11C) when the PV inverter is controlled as a stiff voltage source, including inverter startup, load step changes to 1 pu at time=0.03 seconds(s) and almost 2 pu at time=0.06 s, and a fault at time=0.1 s.

FIG. 11D shows simulation waveforms when the PV inverter is controlled as an active Z source. The upper two waveforms in FIG. 11D are entire waveforms including initial inverter startup, load step changes, and fault protection and restart attempt for the output voltage (vₒ, the uppermost waveform in FIG. 11D) and current (iₒ, the second uppermost waveform in FIG. 11D). The lower two waveforms in FIG. 11D are zoom-in waveforms of the fault dynamic operation, protection, and recovery attempt for the output voltage (vₒ, the second lowermost 10 waveform in FIG. 11D) and current (iₒ, the lowermost waveform in FIG. 11D).

FIG. 11E shows V-I trajectory curves of the PV inverter controlled as an active Z source. The blue curves are the trajectories before the restart. The fine trace and the bold blue curve show instant V-I curve including the initial inverter startup, load step changes and fault dynamic current limiting and protection, which contains switching ripples. The bold blue trace with dots shows the average values over one switching cycle (i.e., after filtering out the switching ripples). The red curve show the restart trajectory.

FIG. 12A shows a single load-to-source connection for a voltage source.

FIG. 12B shows a single load-to-source connection for a current source.

FIG. 13A shows multiple independent loads connected to a voltage source.

FIG. 13B shows multiple independent loads connected to a current source.

FIGS. 14A-14E show the root cause and a natural solution of power instability and congestion. FIG. 14A shows an inductive (or inductance-dominant) two-machine system (a power grid in its simplest form) and its power flow from bus 1 to bus 2. FIG. 14B shows a Resistive (or resistance-dominant) power grid. FIG. 14C shows power curves of inductive (left plot in FIG. 14C) and resistive (right plot in FIG. 14C) power grids. FIG. 14D shows two inductive parallel transmission lines. FIG. 14E shows two resistive parallel transmission lines.

FIGS. 15A-15G show schematics for adding power electronics and controls to transform an inductive (or reactance-dominant) grid to a resistive (or resistance-dominant) one (see also, e.g.; Peng et al. A new approach to harmonic compensation in power systems, 1986 (in Japanese), 1988 IEEE/IAS Annual Meeting, 1990 IEEE Trans. IA; which is hereby incorporated by reference herein in its entirety).

FIG. 16A shows an equivalent circuits of the PV cell farm inverter configuration shown in FIG. 11B, when the PV cell farm and the HV transmission line are controlled as a stiff voltage source. Even when the source is shut-down or reduced to zero volt, the fully charged filter and transformer inductors and capacitors would keep feeding the fault and cause fires.

FIG. 16B shows an equivalent circuits of the PV cell farm inverter configuration shown in FIG. 11B, when the PV cell farm and the HV transmission line are controlled as a Z source and resistive circuit. The PV inverter can virtually place a virtual resistor in each of the three branches (or the L_{f}, C_{f}, and L_{S} branches), respectively, thus making the source and circuit purely resistive. With a zero-volt source and purely resistive circuit, the fault will not get any energy any longer.

FIG. 17 shows a table of wind turbine and permanent magnet synchronous generator parameters.

### DETAILED DESCRIPTION

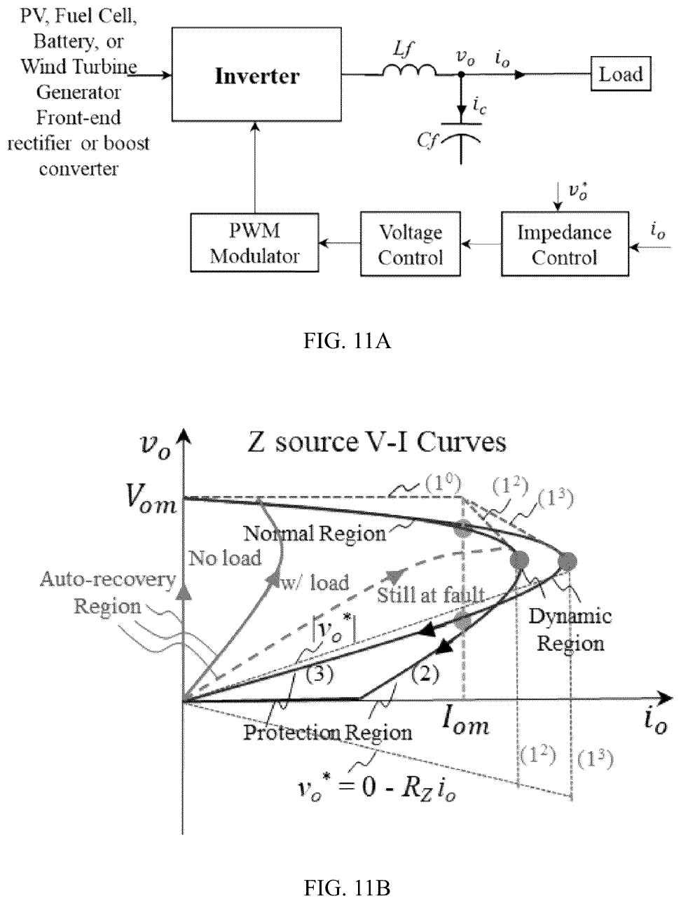

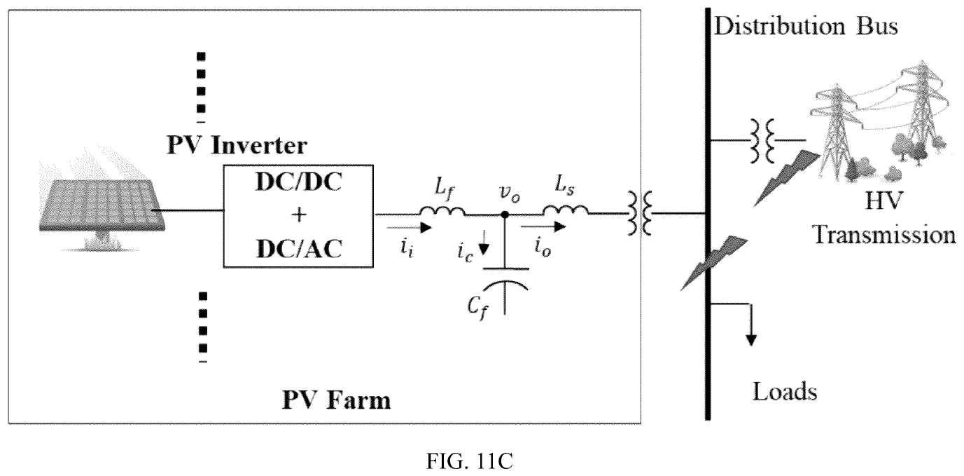

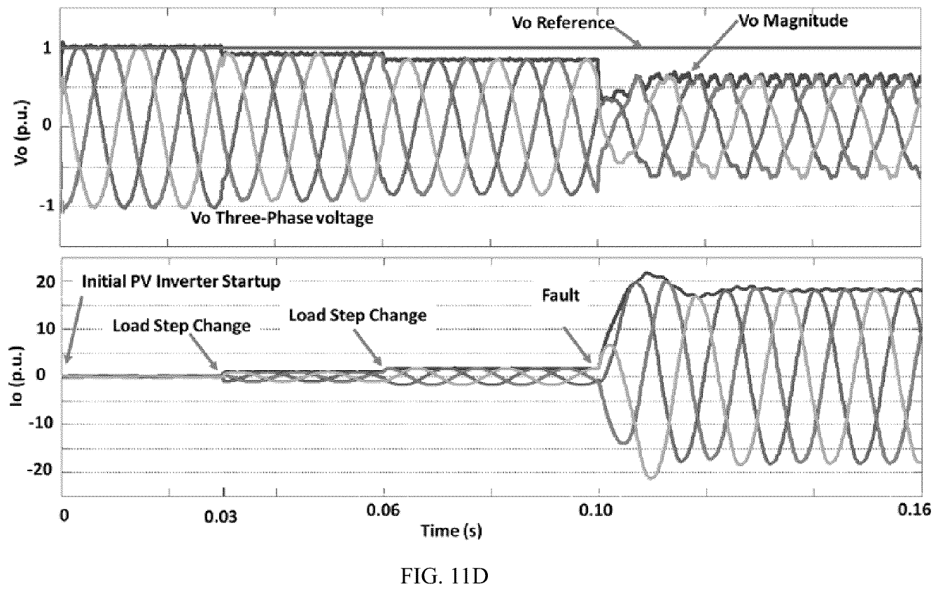

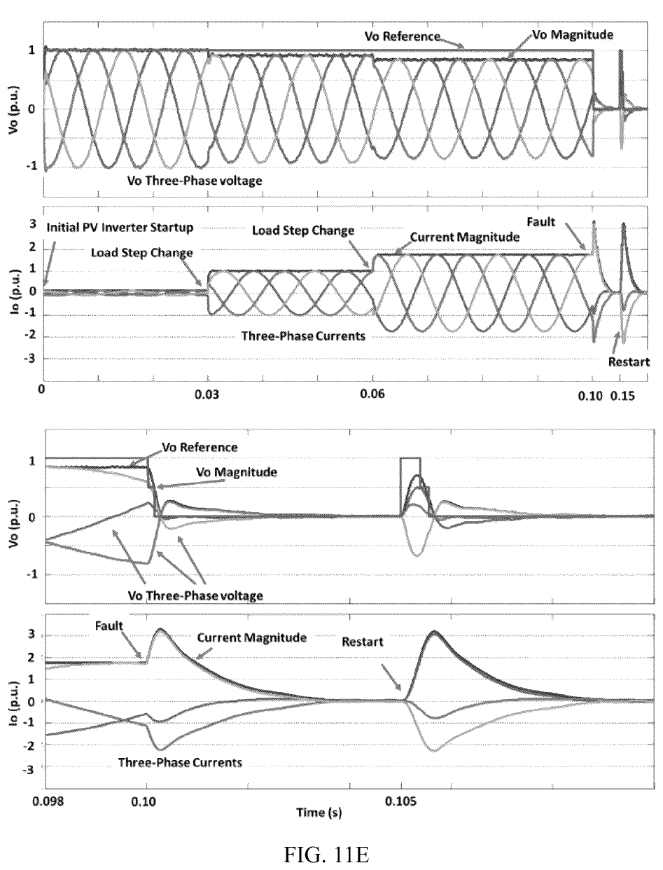

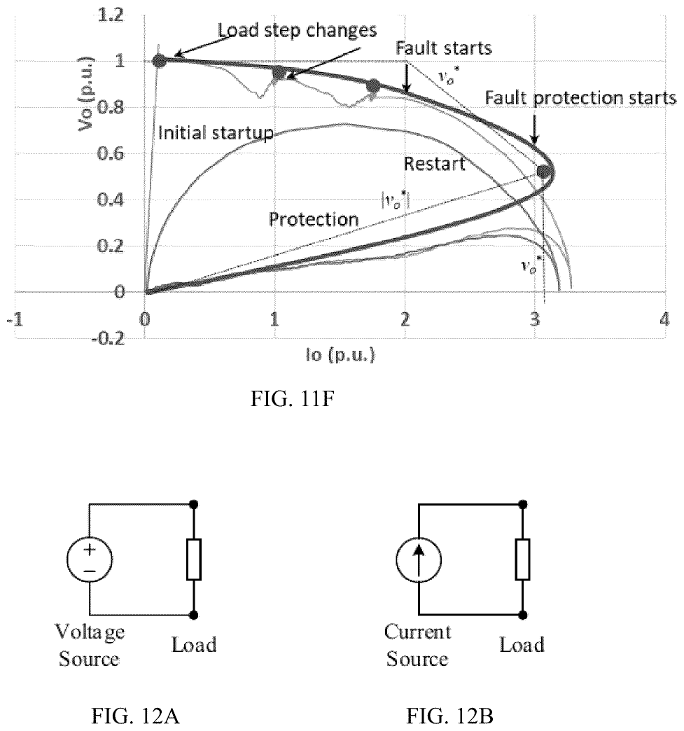

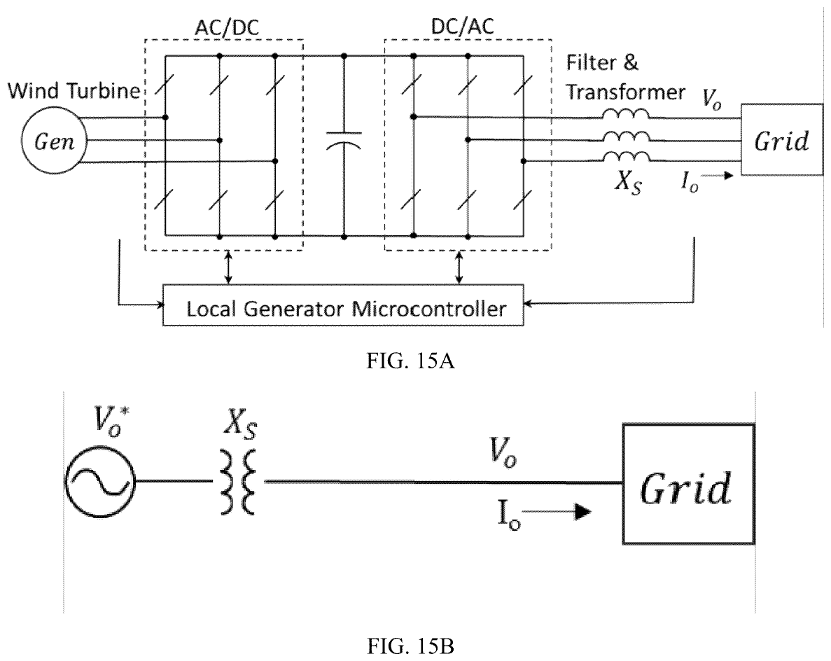

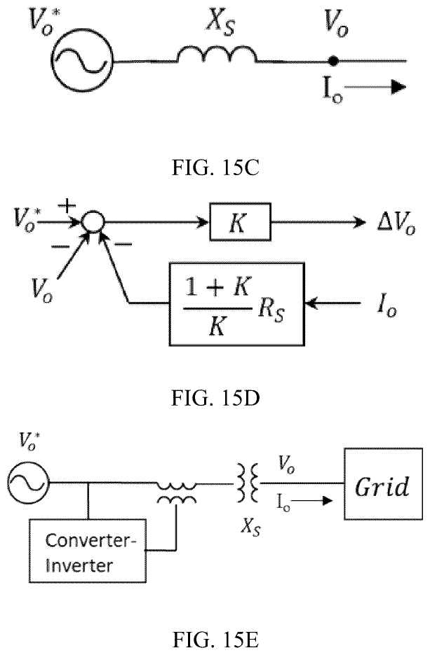

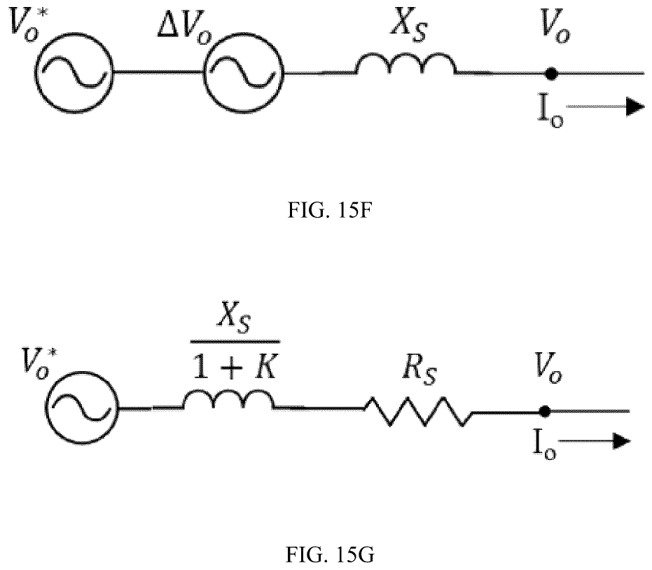

Embodiments of the subject invention provide novel and advantageous systems and methods for re-making/re-engineering electricity power grids to be self-protected, fault-current and/or fault-voltage limited, fast recoverable, and therefore resilient to natural and human-made disasters. Impedance source concepts and models can provide methodological approaches to re-make/re-engineer the electricity power grid(s). All sources can be fault-protected active impedance (Z) sources (see also FIGS. 11A-11F), and/or all grid circuits can be made resistive or resistance-dominant by using power converters/inverters as virtual/active resistors to transform grids to dominantly resistive systems (see also FIGS. 15A-15G).

Any electrical signal source, power source, or energy source can be artificially controlled to behave like a natural Z source. By making all sources fault-protected active Z sources, the following features are achieved: ultrafast fault current limiting within microseconds; self-protection and fault energy capturing; automatic recovery within milliseconds; and inherent and natural self-protection with no need for communication and artificial coordination. By making all grid circuits resistive or resistance-dominant, grids can be naturally balanced, stable, and resilient. Embodiments of the subject invention provide these features and also provide resiliency and fire-free fault protection to electrical signal sources, power sources, and energy sources, as well as the electricity grid. Embodiments do not compromise efficiency while achieving fault-protection and resiliency to extreme conditions like short-circuit or open-circuit caused by natural disasters or human-made events.

The main challenges for fault protection in today's power grids include slow response (typically 50 milliseconds (ms) or longer) of circuit breakers, large time delay and latency in fault detection and communication, and imperfect artificial protection coordination. Protection coordination among a massive number of photovoltaic (PV) inverters within PV farms, and between PV farm and transmission and distribution (T&D) networks is daunting, imperfect, or even impossible. Moreover, a short-circuit fault could trigger a catastrophic fire within a line cycle even before any traditional protection acts due to artificially regulated stiff bus voltages, unresponsive traditional power sources, and dominantly reactive circuits/networks that have inevitably stored up a large amount of energy; all three of these together powerfully feed a faulty circuit. The traditional power grid relies on the stiffness of bus voltages for grid stability and loadability because of its dominantly reactive sources, circuits, and networks.

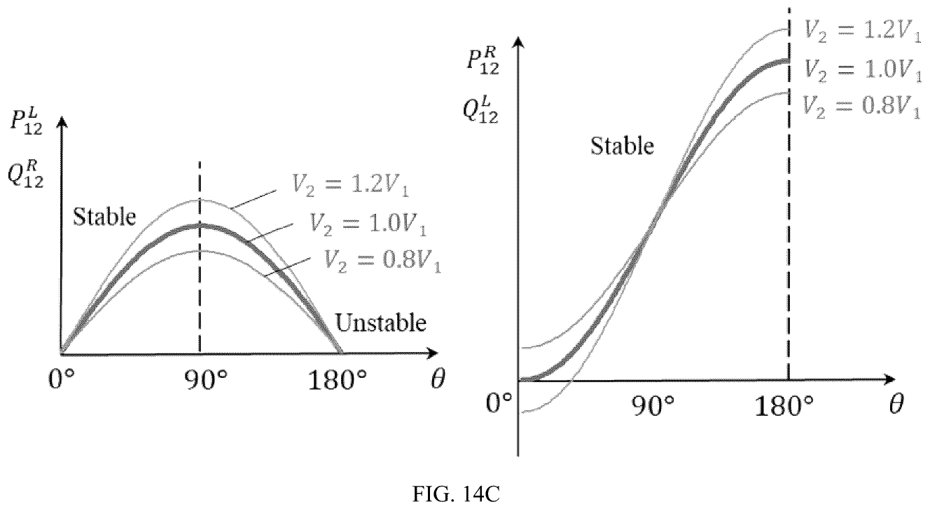

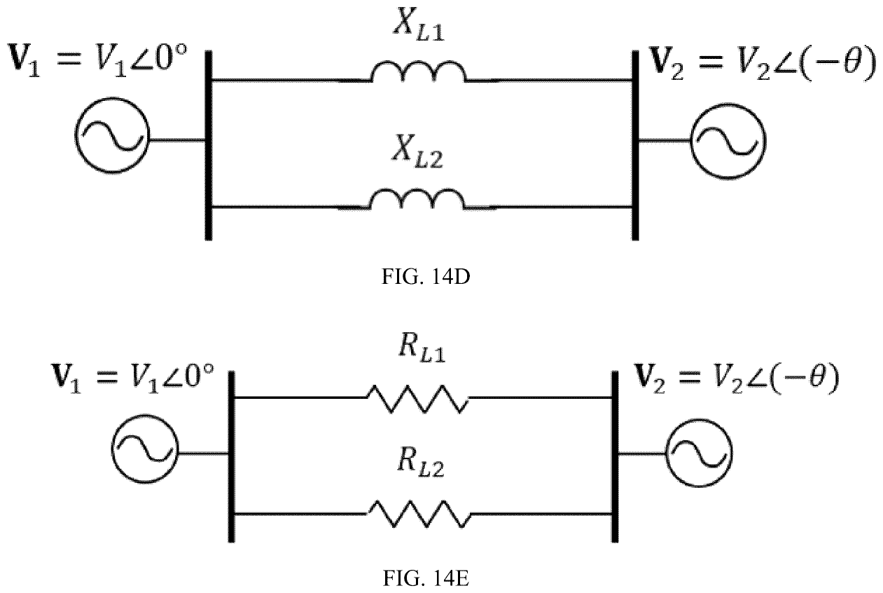

The traditional power grid has instability problem as illustrated in FIG. 14A, in that a two machine system connected by an inductive (or inductance-dominant) impedance delivers power from bus 1 to bus 2 with the governing active and reactive power equations and plotted curves in FIG. 14C. The active power curves as plotted in FIG. 14C exhibit two regions-stable and unstable-separated at the phase angle difference of 90 degrees.

The root cause of power congestion and a natural solution are further illustrated in FIGS. 14D and 14E. The power flow sharing between two inductive transmission lines is determined by their relative reactive reactance, which differ from their thermal limits by their resistances. However, long-distance alternating current (AC) transmission lines could not previously be made dominantly resistive, unless large resistors were physically inserted into the lines, which is not practical because of power losses.

If each PV inverter is controlled like an active Z source illustrated in FIG. 11A with four operation regions, such a huge fault current would be prevented or inhibited. Commanding the output voltage reference to make the entire inverter system including the LC filter like a resistor and keep the inverter running like a resistor are very critical and essential to reduce fault current quickly, and at the same time to capture the already highly charged inductors, capacitors, and transformers in the circuit. The capturing of the inductors, capacitors, and transformers can be done by back feeding their energy to the inverter's direct current (DC) capacitors rather than letting those reactive (yet energy stored) components continue feeding the faulty circuit and cause sparks or fires.

In a resistive power grid as shown in FIG. 14B, the active power curves become monotonically increasing over the entire range of 0 degrees to 180 degrees. A resistive circuit or system is simply physically stable by its nature. This natural solution is advantageous in terms of controllability and resilience. With the approach of embodiments of the subject invention, as depicted in FIGS. 15A-15G, it becomes possible to implement dominantly resistive power lines (or resistive power grids as a whole) without such power losses from physically inserted resistors, thereby not sacrificing efficiency for power grids.

Embodiments of the subject invention provide an impedance source concept to represent, characterize, and model those electricity sources whose output voltage and current are strongly dependent on each other (e.g., wind turbine generators, PV cells, and fuel cells). Many electric sources with no feedback (or active) control of their output voltage and/or current are a natural impedance source with inherent fault protection at short-circuit or open-circuit faults. Also, any electrical source can be artificially controlled to mimic a natural impedance source. Natural impedance sources and nature-mimicking artificially-controlled sources can be applied to the electricity grid, arguably the most complex machine ever made by humans, to realize electricity grids that are naturally stable, self-protected against electrical faults, and resilient to natural and human-made events.

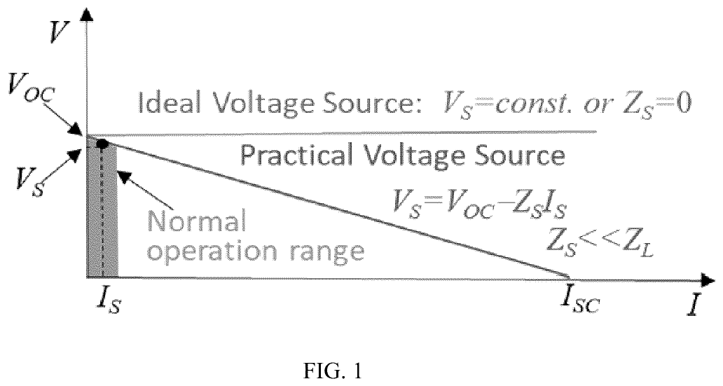

Short-circuit or open-circuit faults in power grids are inevitable because of natural disasters, equipment failures, and human errors. The power grid comprises four main parts or subsystems: generation; transmission; distribution; and end-use consumption. Traditionally, there are two types of electricity sources engineered, voltage sources and current sources. An ideal voltage source is shown in FIG. 1 and generates a constant voltage irrespective of current drawn by its load (i.e., V_{S}=constant). Therefore, an ideal voltage source cannot have a short circuit, which would draw large (theoretically infinite) current and cause damages to the source itself and equipment in its circuit. For a voltage source, no load means an open circuit or zero load current. A more practical voltage source can be regarded as an ideal voltage source with a low series (or internal) resistance for a DC source such as a charged battery, or a low (internal or source) impedance for an AC source such as a generator or grid source. For generality, the term “source impedance” can be used because of two considerations: 1) “impedance” has a broader definition than resistance and is valid for both DC (zero frequency) and AC sources; and 2) a “source” can be naturally inherent or artificially made and controlled. Therefore, “source impedance” as used herein means an internal (or inherent) impedance in a natural source or in a source that is artificially made and controlled.

A typical voltage source's impedance, Z_{S}, is very low, typically 1/10th to 1/100th as compared to its load impedance, Z_{L} (that is, Z_{S}<<Z_{L}), thus having little voltage drop within the source at any normal operating point (V_{S}, I_{S}), as shown in the (green) shaded area of FIG. 1. Therefore, signal, power, or energy lost or wasted in the source is much less as compared to what is received by the load. In other words, the source voltage, V_{S}, is very close to its open-circuit or no-load voltage, V_{OC}. However, the short-circuit current, I_{SC}, would be far greater (10 times to 100 times higher) than its normal operating current. The vast unshaded area from the rated current value to short-circuit current, I_{SC}, is not operable and should be avoided because of potential overcurrent damage.

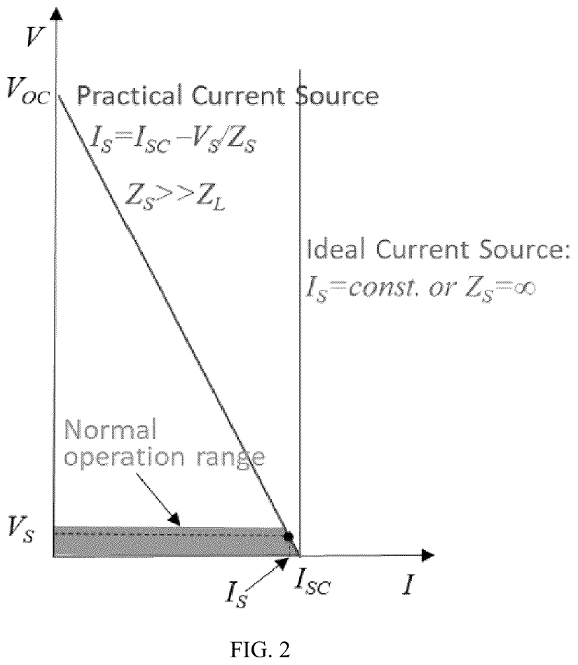

An ideal current source is shown in FIG. 2 and is a source that injects a constant current irrespective of voltage across its load (i.e., I_{S}=constant). For a current source, the higher the load impedance, the higher the terminal voltage across the load gets because of the constant current, and hence the higher is the power output. In contrast to a voltage source, a current source's no-load condition happens at zero resistance/impedance or short circuit. An ideal current source cannot tolerate an open circuit because it would drive the terminal voltage to infinity and destroy the circuit. A practical current source has a relatively high source impedance in parallel with an ideal current source, much higher (typically 10 times to 100 times higher) than its load impedance (that is, Z_{S}>>Z_{L}); thus, the current remains practically constant over the operating range irrespective of load impedance. The operable area as shown in the (green) shaded area is very small and limited, similar to the case of a voltage source.

Most practical sources of electricity are voltage sources. Some sources (e.g., a charged inductor, the secondary of a current transformer) can be regarded as a natural current source. A thyristor-controlled rectifier with a large DC inductor powered from a AC voltage source, which is a superconducting magnetic energy storage system, is a practical current source artificially made.

Traditionally, “ideal” voltage sources and current sources have been sought or engineered to minimize losses and maximize efficiency. However, it is noticeable that the normal operation range of both a voltage source and a current source is limited to a small area, while the vast V-I characteristic area that should be avoided due to excessive overcurrent or overvoltage-caused by a short-circuit fault to a voltage source or an open-circuit fault to a current source-presents the root cause to electric fires and equipment damages. In practice, protection devices and circuits must be used to safeguard circuits/systems from overvoltage or overcurrent damages of equipment with limited capabilities/successes due to detection delays, slow response time of circuit breakers, communication latencies, and protection coordination issues. The vast inoperable and inherent overcurrent/overvoltage region of engineered power sources and protection delays/issues are the root cause of electric fires and resiliency problems.

There are many sources that exhibit a strong interdependency between their output voltage and current, and have an internal source impedance that is naturally close to the intended load impedance (i.e., Z_{S}≈Z_{L}). Thus, they are far away from “ideal” voltage sources or current sources and cannot be simply regarded as a voltage source or a current source. This type of source has been neglected in the mechanical, system control, electrical, and electronic engineering fields. In addition, many artificial sources could be made, engineered, and/or controlled to have a source impedance ideally equal to its load impedance to achieve different purposes, such as maximum signal/power/energy delivery, and reliable/resilient operation.

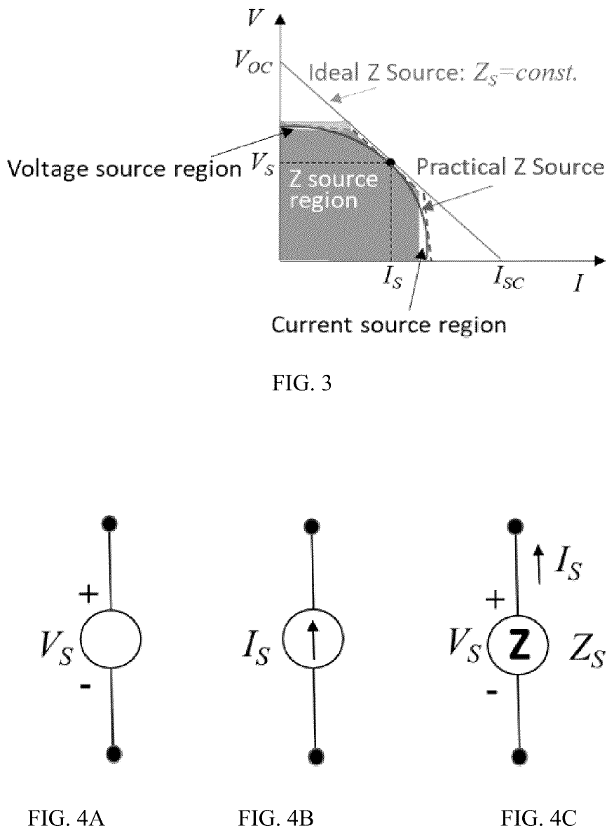

FIG. 3 illustrates the concept and characteristics of a Z source whose output voltage and current are strongly interdependent on each other. An “ideal” Z source exhibits a constant source impedance irrespective of its output voltage and current (i.e., Z_{S}=constant). Unlike a voltage source or a current source, a Z source can be shorted or opened without generating excessive short-circuit current or open-circuit voltage. A practical Z source may behave like the (red) solid-line curve with further limited open-circuit voltage, V_{OC}, and short-circuit current, I_{SC}, which are even closer to their respective voltage and current ratings. The impedance of a Z source is defined as Z_{S}=dV_{S}/d(−I_{S}). A linear Z source exhibits a constant impedance equal to V_{OC}/I_{SC} over the entire operating range, whereas a nonlinear Z source (or a practical Z source as shown in the (red) solid-line curve) has a variant impedance dependent on its operating points. Such a practical, nonlinear Z source can be linearized into three pieces as illustrated in the blue, red, and purple dashed lines and their respective regions: voltage source; Z source; and current source. The Z source region (green area) is the normal operation region, while the voltage-source region (orange area) and current-source region (yellow are) act like a voltage and current limiter.

In summary, a Z source is a third type of electricity source and has the following interesting and distinct features: (1) unlike a voltage source it can be shorted without producing a large short-circuit current; (2) unlike a current source it can be opened without causing a large open-circuit voltage; and (3) its source impedance is comparably close to its load impedance. These three types of electricity sources (their circuit symbols/representations are respectively shown in FIGS. 4A-4C) each has its own distinct characteristics and features and together they cover the entire spectrum of sources. Most renewable energy sources are a natural Z source by themselves or an artificial one by engineering.

A Z source that has no feedback control of its output voltage and/or output current can be referred to as a natural (or passive) Z source. A Z source that has feedback control can be referred to as an artificial (or active) Z source. A discussion on some example natural and passive Z sources follows.

### Natural (or Passive) Z Source: Wind Turbine Generators

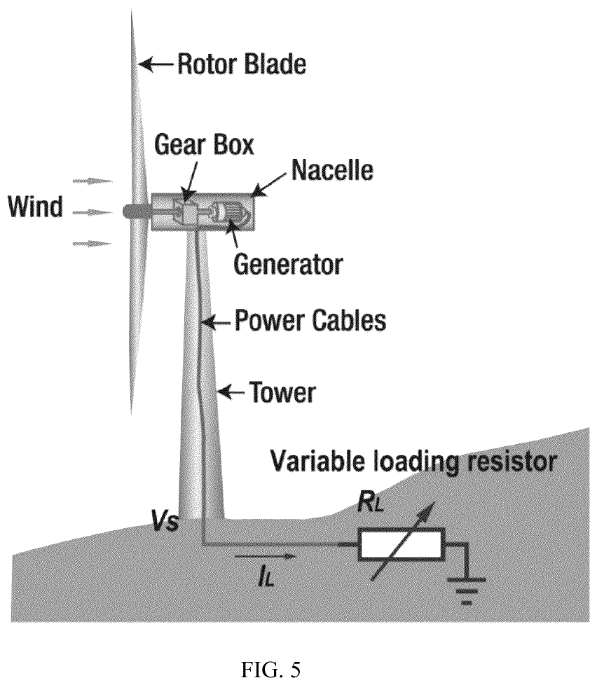

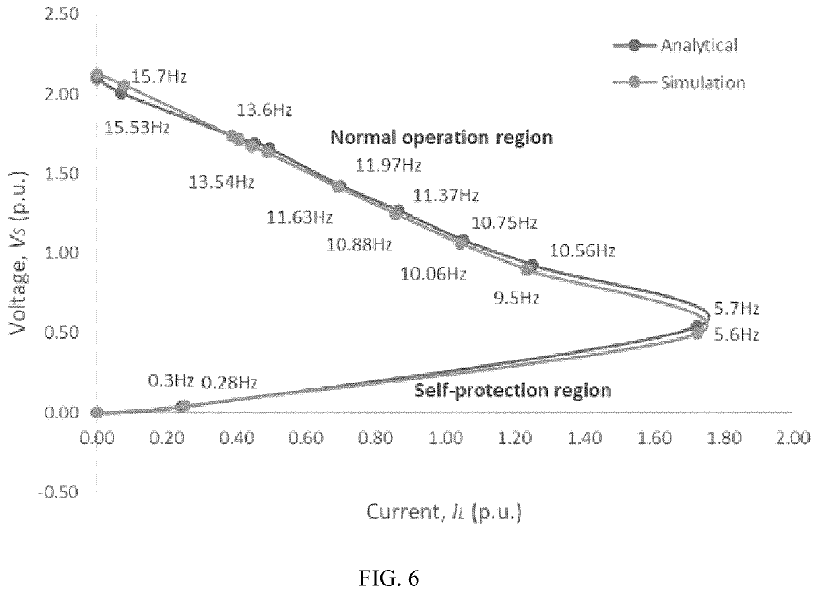

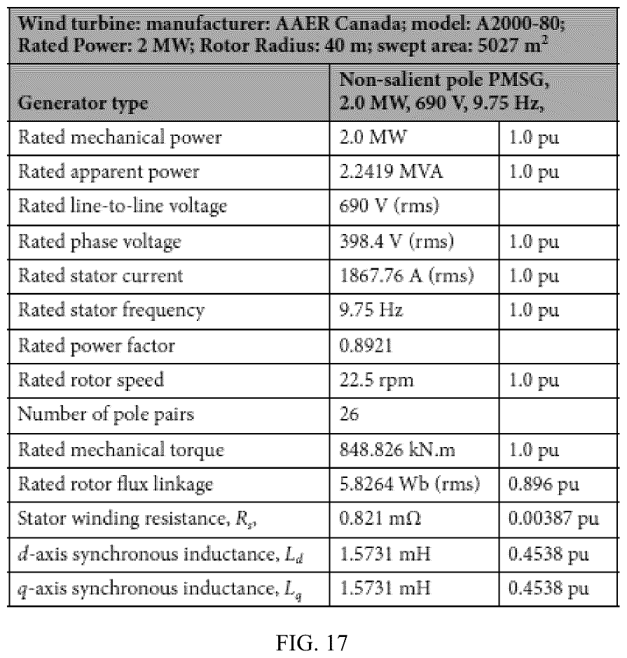

Consider a wind turbine generator with neither artificial mechanical control (such as pitch angle control) of the turbine nor artificial electrical control of the generator's output voltage, current, or power, feeding a variable load resistor, R_{L}, as shown in FIG. 5. FIG. 6 shows the output voltage versus load current (V-I) characteristics obtained by theoretical analysis and simulation of a 2-megawatt (MW) wind turbine generator, whose parameters are shown in the table in FIG. 17. The interesting “big-nose” V-I characteristic curve shows that the output voltage decreases as the load increases (or the load resistance, R_{L}, decreases) from its open circuit (R_{L}=∞) voltage linearly down to the “big-nose” tipping point, behaving just like a Z source. After the “big-nose” tip point, a further attempt of increasing load (or decreasing Rz) actually causes a sharp decrease in the generator output voltage, which naturally reverses the load current trend and reduces load current surprisingly all the way down to zero as the load resistance approaches zero and the turbine comes to a stall. This is an interesting fault protection property, which is natural and inherent to an uncontrolled electric source. It is noticeable that the wind turbine generator's V-I characteristics can be divided into two regions: a normal operation region (or a Z source region); and a fault protection region (or overload region). Therefore, an uncontrolled (or open-loop) wind turbine generator is a natural Z source with fault protection.

### Natural (or Passive) Z Source: PV Cells

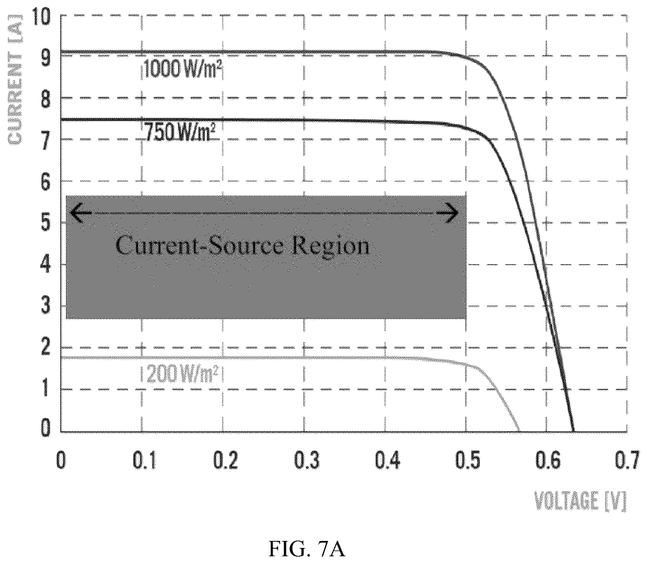

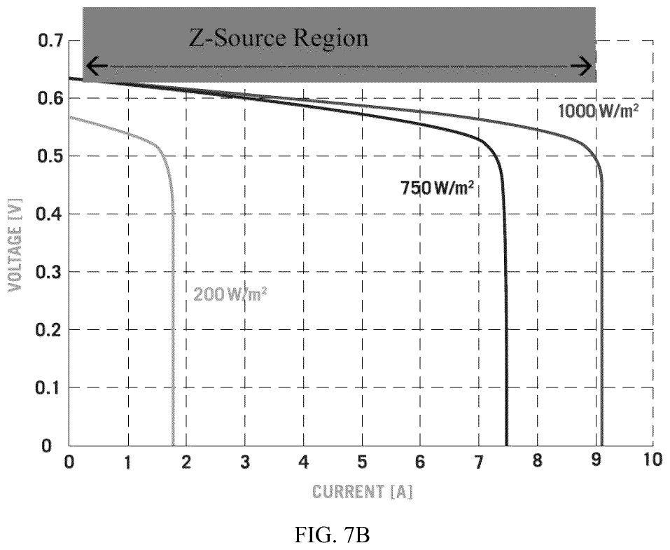

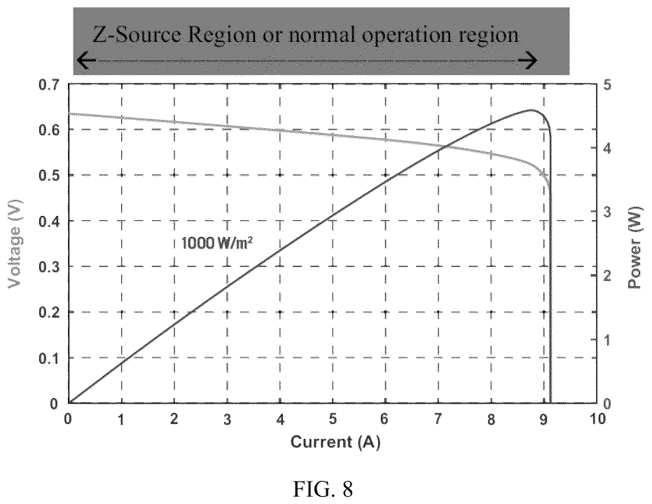

FIG. 7A shows I-V characteristic curves of a typical PV cell. A PV cell when excited by constant intensity light is traditionally modelled as an ideal current source connected with an anti-parallel diode and a shunt admittance (see also, e.g.; Park, H. et al. PV cell model by single-diode electrical equivalent circuit. J. Electr. Eng. Technol. 11 (5), 1323-1331, 2016; which is hereby incorporated herein by reference in its entirety). The curves show a large area as a current source, but redrawing the I-V curves to V-I curves as shown in FIG. 7B unveils a totally different picture, in which the current-source region is very small and negligible. A closer look into one particular V-I curve and its power-current (P-I) curve as shown in FIG. 8 reveals that a PV cell is a good example of a practical Z source as illustrated in FIG. 3, which includes three regions (a small voltage-source region, a small current-source region, and a large Z source region). More notably, a PV cell is normally not operated in its current-source region nor in its voltage-source region despite traditionally being modeled as a current source. Instead, it is normally operated in the Z source region to produce the maximum or close-to-maximum power. In the Z source region, the source impedance (or the source resistance in the DC case) exhibits a source resistance very close to its load resistance (that is, Z_{S}≈Z_{L}, or R_{S}≈R_{L}).

### Natural (or Passive) Z Source: Fuel Cells

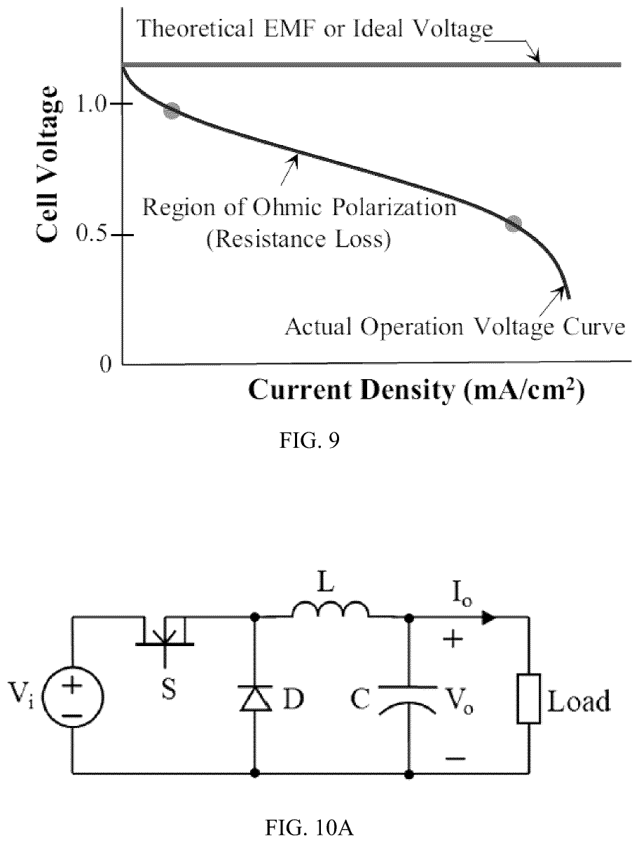

FIG. 9 shows a typical fuel cell polarization curve (or operation voltage curve or V-I characteristic curve) (see also, e.g.; Hoogers, G. Fuel Cell Technology Handbook, CRC Press, 2003; and Braun, R. J., et al. Review of State-of-the-Art Fuel Cell Technologies for Distributed Generation, a Technical and Marketing Analysis, Energy Center of Wisconsin, 2000; both of which are hereby incorporated herein by reference in their entireties). A fuel cell that is far away from its theoretical or “ideal” voltage curve (the straight horizontal line) exhibits significant and strong dependency between output voltage and current like a Z source. Actually, its normal operation region (i.e., the Ohmic (or resistive) polarization region between the two dots as shown in the curve) is characteristically a Z source.

Artificial (or Active) Z Source: a DC-DC Converter with Output Voltage/Current Control

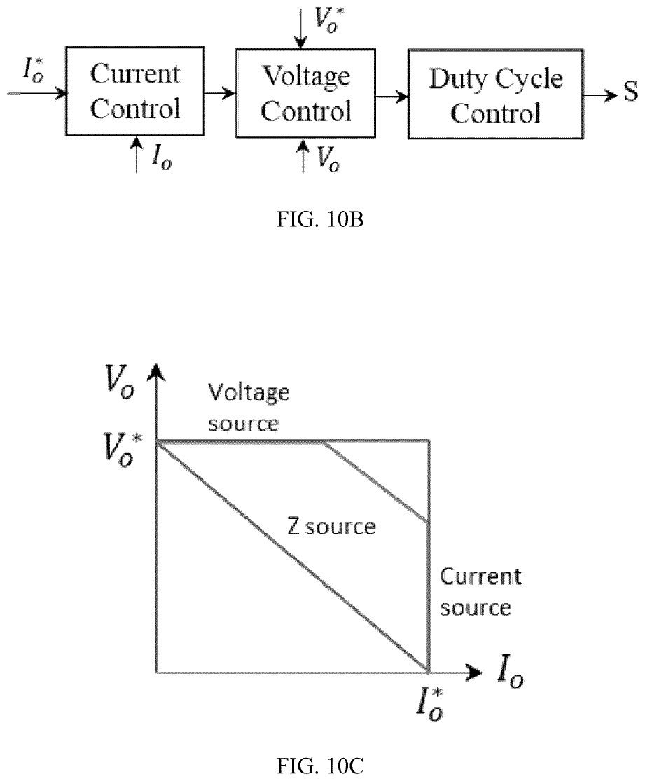

Power electronics is a powerful enabling technology to implement artificial or active Z sources as well as to implement stiff voltage and current sources. A DC-DC converter can be controlled to have any desired output voltage/current relationship-voltage/current equals to impedance or resistance. For example, as illustrated in FIGS. 10A-10C, the converter can be controlled to behave like a voltage source (Vₒ=Vₒ*) for output current is less than its limit, Iₒ<Iₒ*; the converter can be controlled to behave like a current source when the current reaches to its limit, Iₒ=Iₒ*; and the converter can be controlled to behave like a Z source (or a resistive source) represented in diagonal lines if so desired. A DC-DC converter will have inevitable small power losses, which normally amount to less than 1% at utility-scale power ratings, in conduction voltage drop and switching power loss of the semiconductor switching devices. However, no direct power loss is generated from the output voltage/current control. The Z source or resistive region as the voltage source and current source regions just has operational on-drop and switching losses. This output voltage/current control implemented by power electronics is, in fact, an active source impedance or resistance control with a resistance value comparable to its load resistance, which is contradictory to traditional passive sources where a large internal passive resistance would generate large power losses. Therefore, a large internal resistance in a traditional power source is not practical when considering massive heat dissipation and low efficiency.

Artificial (or Active) Z Source: An Inverter-Based Source with Output Voltage/Current Control

Similar to the DC-DC converter, an inverter-based resource (or source) can be controlled like a Z source as shown in FIGS. 11A and 11B. A Z source V-I curve has four regions: normal (with a stiff voltage reference of (10), the flat blue dashed line); dynamic (with a reduced voltage reference like (12) or (13), the diagonal blue dashed lines); fault protection (with a voltage reference like a pure resistance (12) or (13), the red dashed lines); and auto-recovery operations (or regions). The dynamic region has multiple functions, including ultrafast fault current limiting and handling transient current of dynamic loads. Different dynamic Z source curves (or behaviors) can be utilized to meet different dynamic load requirements such as startups, inrush currents, fault clearances, etc. The stiff voltage and current sources (the horizontal and vertical lines of (1), respectively, in FIG. 11B) are for steady-state operation boundaries, and a dynamic V-I trajectory as (2) or (3) could be governed according to tolerable temporary overcurrent magnitude and duration above the steady-state maximum current, Iₒₘ. A criterion can be simply set according to an allowable peak magnitude of the current (iₚ, in Amperes (A)), total charge (i-T, in Ampere-seconds (A-s)), or total energy (i²-T, in Amperes squared-seconds (A²-s))) during a transient period of T. When the dynamic operation cannot reduce the overcurrent to a satisfactory level, fault protection can kick in with a voltage reference as (vₒ*=0−R_{Z} iₒ). Therefore, the inverter source becomes pure resistance to quickly reduce fault current and absorb energy that has built up in the circuit during the fault. The fault protection region is designed according to specific requirements such as the maximum allowable dynamic current and on how fast and how deep the final rest (or reset) point should be for the source. The fault protection region ends at the origin (zero voltage and current), after which an auto-recovery or re-startup of the source can be initiated. If the fault has been cleared, the source will start and follow one of the solid red lines depending on loading conditions. If the fault has not been cleared, the Z source will follow the dashed red line and will enter the over-current dynamic region again, which will trigger another round of protection. This auto-recovery function is one of the greatest features of active Z sources, which can enhance resiliency in great deal.

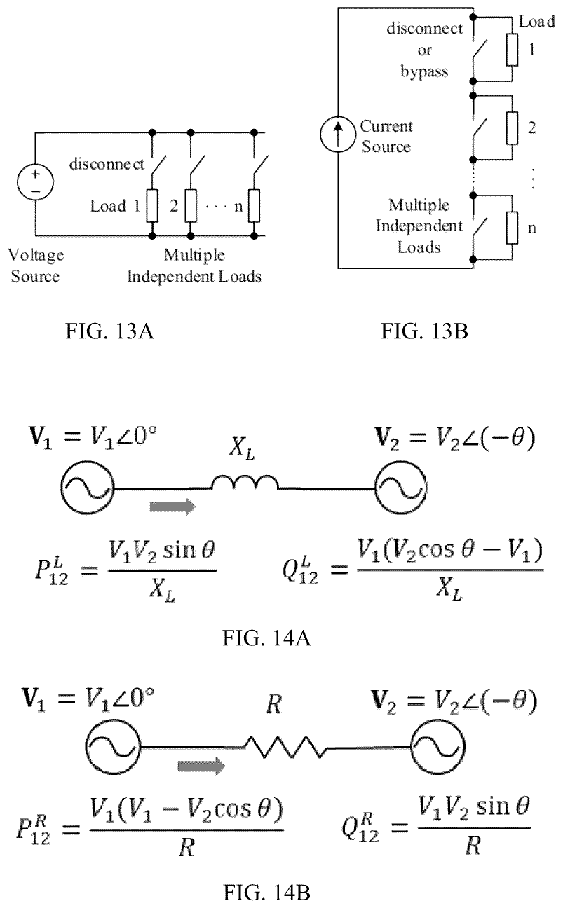

When a single load is connected to a voltage source or a current source, as in FIGS. 12A and 12B, the load should be considered to be connected in parallel with the voltage source, and the load should be considered to be connected in series with the current source. Consider connecting a second load or multiple loads to the source and each load with a disconnect switch, as is done in electricity grids, for independent switch-on and switch-off of individual loads. FIGS. 13A and 13B show the source-load connections for the voltage and current sources, respectively. It can be seen that loads must be connected in parallel with the voltage source and in series with the current source. Although two or more loads can be connected in series together and then as one load to a voltage source, the series-connected loads would have to share the voltage, cannot have their own disconnect switches, and thus will not be independent from each other. Similarly, there is the dual conclusion for the current source. More interestingly, the disconnect switch must be in series with each load for the voltage source-load connection, whereas it must be in parallel with each load for the current source-load connection (it could be thought of as a “bypass switch” for current-source loads).

Theoretically and advantageously, both the parallel and the series source-load connections are operable for a Z source. This can yield many interesting applications that are suited for Z sources.

A voltage source is suited for relatively high impedance loads with low current and high voltage, such as household electric appliances, whereas a current source for relatively low impedance loads with low voltage and high current, such as electronic loads, data center loads, CPU chips, where each load is rated at low voltage (e.g., 1.5 Volts (V)-12 V) and high current (e.g., 10 seconds-Amps (s-A) to 100 s-A). A good application may be wired and wireless charging of electronic devices in series by a single current source.

Most loads today are made as voltage-fed regardless of their suitability. However, the above-mentioned relatively low voltage and high current loads can be (and should be made as) current-fed to fully utilize advantages of current sources.

The Z source offers the above features of both voltage sources and current sources, and is thus suited for almost all the above-mentioned applications. Multiple Z source types of power sources and/or loads can be connected in series, parallel, and/or a combination of series and parallel to achieve maximum system-level flexibility and efficiency. The consideration of how to use the Z source in electricity grids as a whole will now be discussed.

The dual circuit of a voltage source is a current source and vice versa. However, an ideal voltage source can never be replaced by an ideal current source or vice versa. The dual circuit of an impedance source is an admittance source. Admittance is the reciprocal (or inverse) of an impedance (reciprocal mathematical expressions of a circuit's voltage-current relationship); therefore, the dual circuit of an impedance source is physically itself with its reciprocal expression, and so is an admittance source. It is interesting to note that an ideal Z source—when its source impedance (or admittance) matches its load impedance (or admittance) (i.e., Z_{S}=Z_{L})—delivers the maximum signal, power, or energy from the source to load. An ideal voltage source or ideal current source does not have this property.

Even though Z sources have been used, the Z source models of embodiments of the subject invention have not been used in the related art (see also; e.g.; Peng, Z source inverter. IEEE Trans. Ind. Appl. 39 (2), 504-510, 2002; and Peng, Z source networks for power conversion. in Proceedings of the IEEE 23rd Applied Power Electronics Conference and Exposition, pp. 1258-1265, 2008; both of which are hereby incorporated herein by reference in their entireties). Traditionally, a power converter or inverter is fed by either a voltage source or a current source. A voltage source inverter is not allowed to operate at any shoot-through (or short-circuited) switching states that could destroy and explode the inverter. In its dual circuit fashion, a current-source inverter is therefore not allowed to operate at any open-circuited switching states that could destroy and explode the inverter as well. These forbidden short-circuited or open-circuited switching states have been the detrimental reliability problem for power conversion technology due to high speed switching and mis-triggering from electromagnetic interference (EMI) noises. Passive Z source circuits/networks that include inductors (L) and capacitors (C) or distributed LC networks like power cables can be applied to power conversion to solve the detrimental reliability problem, and to actively utilize the traditionally forbidden short-circuited (and open-circuited) switching states for voltage/current step-up or step-down operations with one single stage of power conversion.

The Z source inverters/converters mentioned in the previous paragraph can be implemented by inserting a passive LC network between the source and semiconductor switches to transform the original voltage (essentially capacitive) or current (essentially inductive) source into a Z source that exhibits a comparable impedance at very high frequency (10 s to 1000 s of kHz) for a very short period of time (e.g., microseconds) to make use of those forbidden short-circuited and/or open-circuited switching states without destroying or exploding the inverter. Therefore, passive LC (or Z source) networks have limited applications to power conversion circuits. The Z source models of embodiments of the subject invention have expanded the Z source concept to a new level—the fundamental V-I characteristics in both time and frequency domains—that includes any frequency (from DC to high frequency) and any length of time period (from microseconds to minutes) for electricity grids. This is a totally new application field beyond power conversion, and will be discussed in more detail as follows.

### Implementing Naturally Balanced, Stable, and Resilient Electricity Grids

### The Root Cause of Power Instability and Congestion of Today's Grids and a Natural Solution

FIG. 14A illustrates the classical power grid instability problem: a two machine (V₁ and V₂) system connected by an inductive (or inductance-dominant) impedance, XL, delivers power from bus 1 to bus 2 with the governing active and reactive power equations of P^{L}₁₂ and Q^{L}₁₂, and plotted curves in FIG. 14C (see also; e.g.; Glover et al., Power System Analysis and Design, 7th Ed., Cengage Learning; and Kimbark, Power System Stability, Wiley, 1995; both of which are hereby incorporated herein by reference in their entireties). The active power curves as plotted in FIG. 14C exhibit two regions, stable and unstable, separated at the phase angle difference of 90°. In a resistive power grid as shown in FIG. 14B, the active power curves become monotonically increasing over the entire range of 0° to 180°. A resistive circuit or system is simply physically stable by its nature. This natural solution is advantageous in terms of controllability and resilience, but such resistance-dominant systems would be inefficient and lossy and thus have been avoided by all means in traditional power grids.

The root cause of power congestion and a natural solution are further illustrated in FIGS. 14D and 14E. The power flow sharing between two inductive transmission lines is determined by their relative reactances, which differ from their thermal limits by their resistances. However, two resistive (or resistance dominant) transmission lines-if ever possibly engineered as illustrated in FIG. 14E-do not have such congestion or imbalance problems. They naturally balance out according to their resistance or thermal limits when their inductances are negligible and resistances are dominant. It is true and natural that for DC power transmission, two parallel power lines would never have power sharing, balance, or congestion problems because they are purely resistive and their powers balance out naturally by their thermal resistances.

However, long-distance AC transmission lines could not be made dominantly resistive unless large resistors were physically inserted into the lines, which is not practical because of power losses. Fortunately, with today's power electronics and embodiments of the subject invention, it is possible to implement dominantly resistive power lines (or resistive power grids as a whole) without such power losses from physically inserted resistors, thereby not sacrificing efficiency for grids.

### How to Make Grids Resistive or Resistance-Dominant

Power grids are mostly inductive. FIGS. 15A-15G illustrate how to transform an inductive source or circuit into a resistive one, according to an embodiment of the subject invention. As examples, FIG. 15A shows a full power converter wind turbine generator and FIG. 15B shows a grid bus from a transmission or distribution substation. These originally inductive circuits or sources from an inverter-based resource or a transformer like FIGS. 15A and 15B can be equivalently represented as FIG. 15C, an ideal voltage source with an inductive source impedance X_{S}. Adding a simple control like FIG. 15D to the wind turbine generator's microcontroller or adding a fractionally rated small power converter/inverter in series with the grid circuit/component as in FIG. 15E with the control of FIG. 15D will result in an equivalent controllable source, ΔVₒ, as illustrated in FIG. 15F (see also, e.g.; Peng, Flexible AC transmission systems (FACTS) and resilient AC distribution systems (RACDS) in smart grid, Proc. IEEE 105 (11), 2099-2115, 2017; which is hereby incorporated herein by reference in its entirety). Consequentially, the original inductive source and circuit become dominantly resistive as illustrated in the resultant equivalent circuit of FIG. 15G. The power electronics and control literally minimize the original inductance to a negligible level by a factor of (1+K) and artificially insert a resistor (a virtual resistor), R_{S}, to the circuit. This virtual resistor implemented by power electronics and control introduces no power loss from the resistance while providing the desired damping and stabilization functions for the circuit, system, and grid.

### Nature-Mimicking Method/Approach to Achieve Naturally Balanced, Stable, and Resilient Grids

The nature-mimicking method or approach of embodiments of the subject invention can be summarized as two parts: (1) making all sources fault protected Z sources; and (2) making all grid circuits resistive or resistance-dominant (by today's enabling technologies, power (or energy) electronics, micro-electronics, information technology, and system control engineering). These technologies do not compromise efficiency while achieving fault protection and resiliency to extreme conditions like short-circuit or open-circuit caused by natural disasters or human-made events. As a result, fault protected and resilient electricity grids become possible and the complex machine that is the electricity grid can be transformed into a new future smart and resilient machine.

The Z source concept of electricity and its main features have been described in detail, as have how to make each power source an active Z source (see also FIGS. 11A-11F) and how to make grid circuits/networks dominantly or purely resistive (see also FIGS. 15A-15G). At the grid network level, the Z source concept and its active resistive control can be further extended to more advanced series compensation and control devices such as transformer-less unified power controllers, reactance cancellers, active resistors, and hybrid transformers (that is, a combination of traditional power transformer and inverter).

Embodiments of the subject invention provide resilient and fire-free grids, with resiliency and fire-free fault protection. Resiliency means fast restoration/recovery after a fault. As shown in FIGS. 11A-11F, an immediate recovery attempt can be initiated after each fault protection operation. If the fault has been cleared or isolated naturally like flying debris or by traditional circuit breakers (traditional circuit protection can still be present in the grid), then PV inverters should be restarted. In order to have a fast recovery, certain issues should be addressed: instant startup of each PV inverter; instant synchronization with the grid; transient-less energization of transformers, loads, and networks; and instant black-start of bulk power systems. The Z source concept and resistive control technology have the potential to make them happen (see also, e.g.; Peng et al., Envisioning the future renewable and resilient energy grids—a power grid revolution enabled by renewables, energy storage, and energy electronics, IEEE, 33432 91, 2024; which is hereby incorporated herein by reference in its entirety).

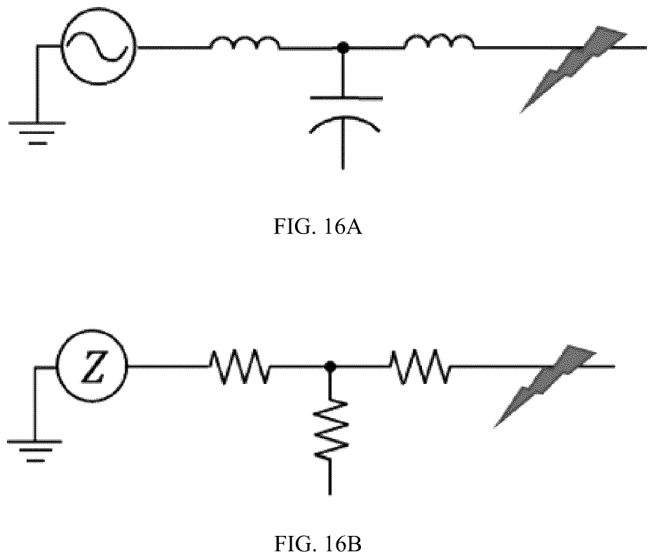

With respect to fire-free fault protection, consider that a 20-MW PV farm is connected to a 500 kilovolt (kV) transmission line. If a tree branch connects with the power line at that high voltage and with that much power on it, it would likely cause a fire in any traditional power grid. FIG. 16A shows an equivalent circuit of the 20-MW PV farm from FIG. 11C. The 500-kV line is controlled/regulated to a stiff voltage source by all the PV inverters and/or transmission substation control devices. Also, all the reactive components and circuits in the grid from each PV inverter all the way to the 500-kV line (i.e., filter inductors and capacitors, high voltage (HV) transformers with their leakage inductance and parasitic capacitance, transmission line inductance and capacitance, and so on) are highly charged and they store a great amount of energy. This can be especially exacerbated during a fault and would feed the faulty line even when the PV farm has been switched off from the line. For example, a HV transformer after being switched off can hold charges or high potentials for hours by its insulation and could cause sparks and fires when accidentally shorting their terminals. A highly charged capacitor is a voltage source that cannot be shorted without causing stress to the circuit and a highly charged inductor is a current source that cannot be opened. Any faults to short a highly charged capacitor or to open a highly charged inductor would likely cause sparks and fires.

However, the Z source concept and resistive control technology of embodiments of the subject invention can address the issues discussed above. If all PV inverters are controlled as a Z source (i.e., a pure resistor during a fault) and make/transform all components and circuits to resistive elements by strategically positioned power electronics (converters and inverters) and control devices in the grid, the PV farm and transmission line shown in FIG. 11C would become what is shown in FIG. 16B, which is a pure resistive circuit during the fault protection. That is, all the AC components and circuits become resistive and grounded through the inverters, and therefore have no energy to the fault. During this fault protection, each PV inverter is running at its full capacity with full or even more DC voltage to keep absorbing energy stored in the circuits and making them like a resistor. All the energy originally stored in the reactive components will eventually be diverted and discharged to the DC capacitors within the PV inverters. As a result, the Z source not only limits fault current within a preset value that is 10 times less than a traditional circuit breaker's interrupt current but also acts at an ultrafast speed (<3 ms, which is more than 10 times faster than traditional circuit breakers that have to wait for zero crossings of their line currents) to bring the fault current down to zero, which may make the grid fire-free.

Embodiments to the subject invention address the issue (identified by the inventors) that the root cause for electrical fires is because power grid sources have been all traditionally engineered and controlled to behave like an ideal voltage source, which is ideal for loads but unintentionally and catastrophically feeding faulty circuits at the same time. Most renewable energy sources without feedback control of their output voltage and/or output current are actually a natural (or passive) Z source of electricity, which has self-protection and fault-current limiting functions. Moreover, with power electronics and active control, any power source can be made to be an active Z source, and the entire grid circuits can be made to be ideally resistive, which in turn results in: ultrafast, inherent, and natural self-protection; fault-current limiting; auto-recovery; and therefore potentially fire-free grids resilient to natural disasters and human-made events.

When ranges are used herein, combinations and subcombinations of ranges (e.g., subranges within the disclosed range) and specific embodiments therein are intended to be explicitly included. When the term “about” or “approximately” is used herein, in conjunction with a numerical value, it is understood that the value can be in a range of 95% of the value to 105% of the value, i.e., the value can be +/−5% of the stated value. For example, “about 1 kg” means from 0.95 kg to 1.05 kg.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1—Specific Active Z Source Case Study and Simulation Results

Following the general description of the active Z source concept provided herein, a specific case study and simulations were performed to verify the main features of active Z sources, such as ultrafast fault current limiting within microseconds (μs), protection and fault energy capturing, automatic recovery within milliseconds (ms), autonomous operation with no need for communication, and artificial coordination. Three PV farms (20 MW, 40 MW, and 80 MW) were examined, all connected to a local utility grid for the US Department of Energy under two research contracts. Each PV farm has hundreds of PV inverters configured as in FIG. 11C.

The main challenges for fault protection in today's grids include slow response (typically 50 ms or longer) of circuit breakers, large time delay and latency in fault detection and communication, and imperfect artificial protection coordination. Protection coordination among the above-mentioned massive number of PV inverters within each PV farm and among PV farms, and between PV farms and T&D networks, is daunting, imperfect, or even impossible. A short-circuit fault could trigger a catastrophic fire within a line cycle even before any traditional protection acts due to artificially regulated stiff bus voltages, unresponsive traditional power sources, and dominantly reactive circuits/networks that have inevitably stored up a large amount of energy; all three together powerfully feed a faulty circuit. The traditional power grid relies on the stiffness of bus voltages for grid stability and loadability because of its dominantly reactive sources, circuits, and networks.

The case study and its simulations were performed to show that the active Z source concept as the foundation has great potential to solve the above fault protection problems. If each PV inverter is controlled simply like a traditional synchronous generator to provide a constant voltage, vₒ, a huge fault current is inevitable when a short-circuit fault happens at any point close to the PV inverter, near local loads, or at the high voltage transmission line as in FIG. 11C. FIG. 11D shows simulation waveforms of a PV inverter output voltage, vₒ, and current, iₒ, including initial inverter startup, load step changes to 1 pu at time=0.03 seconds(s) and to almost 2 pu at time=0.06 s (assuming that the maximum steady-state operation current is 2 pu), and a fault close to loads or at the high voltage lines happens at time=0.1 s. The fault current rapidly rises up to 20 pu within one quarter line cycle (or <5 ms), which eventually will trigger either PV inverter's shut-down and/or circuit breakers. Traditional circuit breakers' protection is too slow to prevent fires. Also, a simple shut-down of the PV inverter is not good either, though it is a traditional way to protect the PV inverter itself. It is not the best way for system protection as a whole because already highly-charged transformers, inductors, and capacitors in the circuit would keep feeding and releasing their stored energy to the faulty circuit, which may cause sparks and fires, even after the PV inverter has been switched off.

If each PV inverter is controlled like an active Z source illustrated in FIGS. 11A and 11B with four operation regions, such huge fault current would be prevented or inhibited, as shown in FIG. 11E for the simulation waveforms, and FIG. 11F for their V-I curves and trajectories. The PV inverter is controlled as a stiff voltage source in the normal operation region when iₒ<Iₒₘ (which is preset to 2 pu). When the current rapidly rises at a fault and exceeds its 2-pu limit, the PV inverter enters the dynamic region with reduced voltage reference to slow down and limit the fault current at an ultrafast speed within one inverter switching cycle (or microseconds). In this case, the switching frequency is 10 kilohertz (kHz) or a 100 μs switching cycle. Within each switching cycle, there are 6 times of switching for a 2-level inverter and 12 times for a 3-level inverter). If the current still keeps rising and reaches its protection point (a preset value of 3 pu in the simulation), the PV inverter's output voltage reference is commanded to zero minus virtual resistance drops, thus forcing it to behave like a pure resistor when viewed from the fault (or vₒ*=0−(Rᵢ iᵢ+R_{Cf} i_{C})=0−R_{Z} iₒ) and the inverter enters the protection operation/region. As a result, the PV inverter successfully brings the fault current down to its 2-pu limit within 1 ms and further down to zero within 3 ms. It is noteworthy that commanding the output voltage reference to make the entire inverter system including the LC filter like a resistor and keeping the inverter running like a resistor are very critical and essential to reduce fault current quickly and at the same time to capture the already highly charged inductors, capacitors, and transformers in the circuit by back-feeding their energy to the inverter's DC capacitors rather than letting those reactive (yet energy stored) components continue feeding the faulty circuit and cause sparks or fires.

Following the successful protection operation that has brought the output voltage and current down to zero, a recovery restart was initiated immediately (only 5 ms after the initial fault) as shown in the simulation. Because the fault has not been cleared, the attempt caused a rapid current rise and triggered another round of protection. However, if the fault had been cleared, the PV inverter would startup like the initial startup and restore the system. The simulation waveforms and actual operational V-I trajectories plainly demonstrated the main features of active Z sources: ultrafast fault current limiting within microseconds (μs); self-protection and fault energy capturing; automatic recovery within milliseconds (ms); inherent and natural self-protection with no need for communication; and artificial coordination. As a result, the Z source control makes it possible to have resilient PV farms and fire-free faults.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section, if present) are incorporated by reference in their entirety, including all figures and tables, to the extent they are not inconsistent with the explicit teachings of this specification.

### REFERENCES

1. nfpa.org/News-and-Research/Publications-and-media/Blogs-Landing-Page/NFPA-Today/Blog-Posts/2023/08/12/Maui-wildfire-one-of-deadliest-in-US-history
2. nytimes.com/2023/08/14/us/hawaiian-electric-maui-wildfire.html
3. cnn.com/2023/08/15/us/hawaii-maui-wildfires-death-toll-tuesday/index.html
4. theverge.com/2022/1/5/22868 298/pge-utility-power-line-responsible-dixie-fire
5. Alexander, C. & Sadiku, M. Fundamentals of Electric Circuits, 7th Ed. (McGraw-Hill Education, 2021).
6. Circuit Globe. Voltage Source and Current Source. https://circuitglobe.com/voltage-source-and-current-source.html
7. Park, H. et al. PV cell model by single-diode electrical equivalent circuit. J. Electr. Eng. Technol. 11 (5), 1323-1331. https://doi.org/10.5370/JEET.2016.11.5.1323 (2016).
8. Hoogers, G. Fuel Cell Technology Handbook (CRC Press, 2003).
9. Braun, R. J., et al. Review of State-of-the-Art Fuel Cell Technologies for Distributed Generation, a Technical and Marketing Analysis (Energy Center of Wisconsin, 2000).
10. Peng, F. Z. Z source inverter. IEEE Trans. Ind. Appl. 39 (2), 504-510 (2002).
11. Peng, F. Z. Z source networks for power conversion. in Proceedings of the IEEE 23rd Applied Power Electronics Conference and Exposition, pp. 1258-1265 (2008).
12. Glover, J. D., et al. Power System Analysis and Design, 7th Ed. (Cengage Learning).
13. Kimbark, E. W. Power System Stability (Wiley, 1995).
14. Peng, F. Z. Flexible AC transmission systems (FACTS) and resilient AC distribution systems (RACDS) in smart grid. Proc. IEEE 105 (11), 2099-2115 (2017).
15. Peng, F. Z. et al. Envisioning the future renewable and resilient energy grids—a power grid revolution enabled by renewables, energy storage, and energy electronics. IEEE JESTIE https://doi.org/10.1109/JESTIE.2023.33432 91 (2024).
16. National Academy of Engineering Report on Greatest Achievements. http://www.greatachievements.org.
17. Wu, B., et al. Power Conversion and Control of Wind Energy Systems (Wiley, 2011).
18. thewindpower.net/turbine_en_107_aaer.php
19. Data sheet Q6LMXP3-G3 (solar cell), https://www.q-cells.eu
20. Peng, F. Z. et al. “A new approach to harmonic compensation in power systems,” 1986 (in Japanese). 1988 IEEE/IAS Annual Meeting. 1990 IEEE Trans. IA.

What is claimed is:

1. A system for a resilient power grid, the system comprising:
at least one power source, wherein each power source of the at least one power source is a fault-protected active impedance source; and
at least one grid circuit in operable communication with the at least one power source, wherein each grid circuit of the at least one grid circuit is a resistance-dominant grid circuit.

2. The system according to claim 1, wherein each grid circuit of the at least one grid circuit comprises:
a) a power converter as a virtual resistor;
b) a power inverter as an active resistor; or
c) both a) and b).

3. The system according to claim 1, wherein each grid circuit of the at least one grid circuit comprises:
a) a plurality of power converters as a plurality of virtual resistors, respectively;
b) a plurality of power inverters as a plurality of active resistors, respectively; or
c) both a) and b).

4. The system according to claim 1, wherein the at least one power source comprises a plurality of power sources, and
wherein the at least one grid circuit comprises a plurality of grid circuits.

5. The system according to claim 1, wherein the at least one power source comprises at least one passive impedance source.

6. The system according to claim 1, wherein the at least one power source comprises at least one active impedance source.

7. The system according to claim 1, wherein the at least one power source comprises at least one of a wind turbine generator, a photovoltaic cell, a fuel cell, a direct current-direct current (DC-DC) converter with output control, and an inverter-based source with output control.

8. The system according to claim 1, wherein the system is configured for fault current limiting within a period of time of less than 500 microseconds (μs).

9. The system according to claim 1, wherein the system is configured for automatic recovery after a fault within a period of time of less than 500 milliseconds (ms).

10. The system according to claim 1, wherein the system is configured for at least one of:
a) protection and fault energy capturing;
b) autonomous operation with no need for communication; and
c) artificial coordination.

11. A method for re-engineering a power grid to be resilient, the power grid comprising at least one power source and at least one grid circuit in operable communication with the at least one power source, the method comprising:
making each power source of the at least one power source a fault-protected active impedance source; and
making each grid circuit of the at least one grid circuit a resistance-dominant grid circuit.

12. The method according to claim 11, wherein each grid circuit of the re-engineered resilient power grid comprises:
a) a power converter as a virtual resistor;
b) a power inverter as an active resistor; or
c) both a) and b).

13. The method according to claim 11, wherein each grid circuit of the re-engineered resilient power grid comprises:
a) a plurality of power converters as a plurality of virtual resistors, respectively;
b) a plurality of power inverters as a plurality of active resistors, respectively; or
c) both a) and b).

14. The method according to claim 11, wherein the at least one power source comprises a plurality of power sources, and
wherein the at least one grid circuit comprises a plurality of grid circuits.

15. The method according to claim 11, wherein the at least one power source comprises at least one passive impedance source.

16. The method according to claim 11, wherein the at least one power source comprises at least one active impedance source.

17. The method according to claim 11, wherein the at least one power source comprises at least one of a wind turbine generator, a photovoltaic cell, a fuel cell, a direct current-direct current (DC-DC) converter with output control, and an inverter-based source with output control.

18. The method according to claim 11, wherein the re-engineered resilient power grid is configured for fault current limiting within a period of time of less than 500 microseconds (μs).

19. The method according to claim 11, wherein the re-engineered resilient power grid is configured for automatic recovery after a fault within a period of time of less than 500 milliseconds (ms).

20. The method according to claim 11, wherein the re-engineered resilient power grid is configured for at least one of:
a) protection and fault energy capturing;
b) autonomous operation with no need for communication; and
c) artificial coordination.
